(19) United States
(12) Patent Application Publication
(10) Pub. No.: US 2023/0402717 A1
(43) Pub. Date: Dec. 14, 2023

(54) CELL CONNECTOR FOR AN ENERGY STORAGE DEVICE, AND ENERGY STORAGE DEVICE

(71) Applicants: Diehl AKO Stiftung & Co. KG, Wangen (DE); Diehl Advanced Mobility GmbH, Zehdenick (DE)

(72) Inventors: Ingo Weber, Potsdam (DE); Tejas Harish Navsariwala, Berlin (DE); Markus Kohler, Nürnberg (DE); Mateusz Kurpiel, Wangen (DE); Artur Dick, Strausberg (DE); Kian Mahdjour, Berlin (DE); Silke Abreder, Sauldorf (DE); Artur Schütz, Wangen (DE); David Jäger, Lindenberg (DE); Bernhard Lutz, Wangen (DE)

(21) Appl. No.: 17/941,197

(22) Filed: Sep. 9, 2022

(30) Foreign Application Priority Data
Jun. 10, 2022 (DE) 10 2022 114 654.5
Jul. 5, 2022 (DE) 10 2022 116 707.0

(51) Int. Cl. H01M 50/503; H01R 11/01; H01M 50/209; H01M 10/653; H01M 50/522; H01M 50/30; H01M 10/625; B60L 50/64

(52) U.S. Cl. CPC H01M 50/503; H01R 11/01; H01M 50/209; H01M 10/653; H01M 50/522; H01M 50/30; H01M 10/625; B60L 50/64; H01R 2201/26; H01M 2220/20

(57) ABSTRACT

A cell connector for an energy storage device for electrically contacting a first pole contact of a first energy storage cell and a second pole contact of a second energy storage cell of the energy storage device, in particular an energy storage device for a vehicle, includes an electrically conductive main body, preferably composed of a flat material with a constant layer thickness, in particular composed of sheet metal, with a first contact face which serves to electrically contact the first pole contact and a second contact face which serves to electrically contact the second pole contact. The main body is provided, preferably overmolded, in a partial region with a temperature control structure which increases the surface area of the cell connector. An energy storage device, in particular energy storage device for a vehicle, is also provided.

### CROSS-REFERENCE TO RELATED APPLICATION

This application claims the priority, under 35 U.S.C. § 119, of German Patent Applications DE 10 2022 114 654.5, filed Jun. 10, 2022, and DE 10 2022 116 707.0, filed Jul. 5, 2022; the prior applications are herewith incorporated by reference in their entirety.

### FIELD AND BACKGROUND OF THE INVENTION

The present invention relates to a cell connector for an energy storage device for electrically contacting a first pole contact of a first energy storage cell and a second pole contact of a second energy storage cell of the energy storage device, in particular an energy storage device for a vehicle, including an electrically conductive main body with a first contact face which serves to electrically contact the first pole contact and a second contact face which serves to electrically contact the second pole contact. The invention also relates to a cell connector for an energy storage device for electrically contacting a pole contact of an energy storage cell of the energy storage device, in particular an energy storage device for a vehicle, including an electrically conductive main body with a contact face which serves to electrically contact the pole contact, and a current tap. The invention further relates to an energy storage device, in particular energy storage device for a vehicle, having a plurality of energy storage cells disposed in a row.

A central point in the development of electrically powered means of transport, for example electric vehicles, is energy storage. This requires energy storage devices with a high power density and energy density. Energy storage devices are regularly formed of a plurality of individual energy storage cells (for example lithium ion battery cells) that are electrically connected to each other. Energy storage devices usually require temperature management to ensure their operation in an optimized temperature range. The energy storage cells usually have a narrow operating temperature range (for example between +15° C. and +45° C.). The functional safety, service life and cycle stability of the energy storage cell and thus also the functional safety of the entire energy storage device depend significantly on the energy storage cell not leaving this range. If the temperature exceeds a critical level, a so called “thermal runaway” occurs. In the case of thermal runaway, an unstoppable chain reaction is set in motion. The temperature rises extremely within milliseconds and the energy stored in the energy storage cell is released suddenly. In this way, temperatures of over 1000° C. can occur. The contents of the energy storage device become gaseous and a fire occurs that is difficult to extinguish by conventional measures. The danger of a thermal runaway starts at a certain temperature (for example 60° C.) and becomes extremely critical at a further temperature threshold (for example 100° C.). As a result, energy storage devices, especially energy storage devices for electric vehicles, use an energy storage device management system that not only provides open loop or closed loop control of the charging and discharging behaviour of the energy storage cells, but also takes measures with regard to temperature management and emergency management in the event of a thermal runaway. In order to ensure a targeted escape of gases in the event of a thermal runaway, the gas tightly sealed energy storage cells can have degassing openings. The degassing openings can, for example, be configured as predetermined breaking points which allow gases to escape from the interior of the energy storage cell to the surrounding environment above a certain internal pressure. The escaping gases may contain electrolytes that can react with water to form hydrofluoric acid. In order to reduce the danger to surrounding components and/or individuals, such gases must be discharged in a controlled and targeted manner.

In order to provide for the electrical connection of the energy storage cells, energy storage devices have so called cell connectors that electrically connect two or more poles of two or more energy storage cells, depending on the circuit type. In a series circuit, for example, the anode of one energy storage cell is connected to the cathode of another energy storage cell. In order to be able to monitor and control the state of charge of each energy storage cell, each cell connector can be electrically connected to the open loop and/or closed loop control electronics of the energy storage device. This allows the cell voltage of each individual energy storage cell to be measured and the state of charge of each particular energy storage cell to be deduced through the cell voltage. Furthermore, sensors, for example temperature sensors for monitoring the surface temperature of the energy storage cells, can also be provided, which are connected to the open loop and/or closed loop control electronics. In previous solutions, the open loop and/or closed loop control electronics are located in an independent module.

### DESCRIPTION OF THE RELATED ART

German Patent Application DE 10 2007 063 178 A1 discloses a battery with a heat conducting plate for controlling the temperature of the battery. The battery includes a plurality of interconnected individual cells. The heat conducting plate has holes and/or incisions in the region of the poles of the individual cells, through which the poles of the individual cells protrude in or out. The heat conducting plate is disposed between the individual cells and contacting elements placed on the poles. Electrical cell connectors and/or a cell connector circuit board are provided as contacting elements for the electrical connection of the poles of the individual cells. Furthermore, elastic elements and/or contacting elements may be located on the upper side of the heat conducting plate. This sequence of these individual layers must be clamped to the individual cells by screws during the assembly process. The assembly is therefore time consuming.

German Patent Application DE 10 2009 046 385 A1, corresponding to U.S. Patent Application Publication No. 2013/0059175 A1, discloses a battery with a degassing system. The degassing system is located on the side opposite the poles of the battery cells. A base plate provided specially for this purpose is provided there, with passages for degassing openings and a collection basin for collecting the gases from the battery cells.

German Patent Application DE 10 2012 219 784 A1 discloses a battery module including a gas channel, a printed circuit board and a battery module housing which accommodates a plurality of battery cells. The gas channel is formed by a U profile with through openings to the degassing openings of the battery cells and by a printed circuit board closing the U profile on the side facing away from the degassing openings. The printed circuit board thus forms a wall of the gas channel and can come into direct contact with the gas when gas escapes from a gas outlet opening of a battery cell. During assembly, the printed circuit board is attached directly to the busbars. The U profile is not directly connected to the busbars. The disadvantage of this arrangement is that escaping gas can destroy the unprotected circuit board. In this case, open loop and/or closed loop control of the battery module is no longer ensured. Furthermore, no active temperature control of the battery cell surface or of the cell connectors is provided.

European Patent Application EP 3 316 384 A1, corresponding to U.S. Pat. No. 11,127,990 B2, discloses a circuit board arrangement as described above. A rigid circuit board for open loop and/or closed loop control electronics is provided, to the surface of which there are directly applied cell connectors for connecting the energy storage cells. Due to this direct connection of the cell connectors to the open loop and/or closed loop control electronics, a direct heat transfer from the electrical connections of the energy storage cells to the open loop and/or closed loop control electronics takes place. Such an arrangement leads to unavoidable measurement deviations in the voltage and temperature measurement. Furthermore, a C shaped flexible printed circuit board carrying a temperature sensor element is fixed to the rigid circuit board. The flexible printed circuit board extends through a slot shaped through opening in the rigid circuit board. The construction is complex and costly, both in terms of the production of the individual parts and in terms of final assembly.

### SUMMARY OF THE INVENTION

It is accordingly an object of the invention to provide a cell connector for an energy storage device, and an energy storage device, which overcome the hereinafore-mentioned disadvantages of the heretofore-known cell connectors and devices of this general type and which have improved temperature control.

With the foregoing and other objects in view there is provided, in accordance with the invention, a cell connector for an energy storage device for electrically contacting a first pole contact of a first energy storage cell and a second pole contact of a second energy storage cell of the energy storage device, in particular an energy storage device for a vehicle, comprising an electrically conductive main body, preferably composed of a flat material with a constant layer thickness, in particular composed of sheet metal, with a first contact face which serves to electrically contact the first pole contact and a second contact face which serves to electrically contact the second pole contact. According to the invention, the main body is provided, preferably overmolded, in a partial region with a temperature control structure which increases the surface area of the cell connector. This ensures particularly good temperature control of the cell connector.

With the objects of the invention in view, there is also provided a cell connector for an energy storage device for electrically contacting a pole contact of a first or last energy storage cell of the energy storage device, in particular an energy storage device for a vehicle, comprising an electrically conductive main body, preferably composed of a flat material with a constant layer thickness, in particular composed of sheet metal, with a contact face which serves to electrically contact the pole contact, and a current tap. According to the invention, the main body is provided, preferably overmolded, in a partial region with a temperature control structure which increases the surface area of the cell connector. This ensures particularly good temperature control of the cell connector.

Advantageously, the main body can have a first side and a second side and the temperature control structure can extend along the entire length of the first side. This configuration is advantageous if the cell connector does not have a current tap.

Expediently, the main body can have a first side and a second side and the temperature control structure can extend only along the length of the first side in the region of the first contact face. This configuration is advantageous if the cell connector has a current tap.

The first side of the main body extends in the contacting direction of the energy storage cells.

Furthermore, the first and the second contact face can be separated from one another by at least one recess. This configuration is advantageous if the cell connector does not have a current tap. The cell connector can have a certain degree of elasticity due to this recess. In the case of a first and a second contact face connected to energy storage cells, relative movements of the energy storage cells can be compensated for due to the elasticity. In addition, the flow of current can be shifted in the direction of the overmolded partial region by the recess.

In an expedient configuration, the temperature control structure can include a plurality of temperature control ribs, temperature control nubs, temperature control pins and/or temperature control bars. As a result, particularly effective temperature control and/or flow of the temperature control fluid can be achieved as a function of the temperature control fluid surrounding the temperature control structure.

Expediently, the temperature control ribs, temperature control nubs, temperature control pins and/or temperature control bars can be disposed in series with one another, parallel to one another and/or at equal distances from one another for this purpose.

The fact that the temperature control structure is formed of a thermally conductive, electrically insulating material, in particular a thermally conductive, electrically insulating plastic, means that particularly good heat transfer and electrical insulation of the cell connector take place.

In order to provide additional temperature control of the surface of an energy storage cell, a contact element can be provided with a contact face for contacting the surface of the energy storage cell and the contact element can be connected to the temperature control structure.

In an advantageous configuration, the contact element can be part of the temperature control structure.

In an alternative configuration, the contact element can be a contact plate, preferably composed of a sheet metal.

There can be a gap between the contact plate and the main body, and the temperature control structure can join the main body and the contact plate to one another in the region of the gap. The contact plate and the main body can be electrically isolated from one another by the gap.

The fact that the first and/or the second contact face and the contact face of the contact element are positioned with a vertical offset in relation to one another means that thermal and electrical contacting of the first and/or the second contact face to the pole contacts of the energy storage cell and thermal contacting of the contact element to the surface of the energy storage cell are possible.

Expediently, the vertical offset can be formed by at least one bent portion of the contact element.

Advantageously, the at least one bent portion can be provided on both sides of the temperature control structure.

Particularly expediently, the main body and the contact element are punched parts or cut parts, preferably laser cut parts, from a common plate-like blank. As a result, the main body and the contact element can be produced in a particularly cost-effective manner, without waste occurring during production of the contact element.

In a further advantageous configuration, the contact element can extend as far as at least one degassing opening of the first and/or the second and/or the last energy storage cell, preferably as far as the degassing openings of the first and the second energy storage cell, preferably can at least partially enclose the degassing openings.

Furthermore, the contact element can partially or completely enclose an energy storage cell by way of the pole contact.

Expediently, the temperature control structure can form an interface to a thermal conditioning system.

In an advantageous configuration, the thermal conditioning system can have at least one temperature control channel in which the temperature control structure of the cell connector can be positioned.

In a particularly advantageous embodiment, the electrically conductive main body can be formed of a, preferably small plate-shaped, flat material with a constant layer thickness or of a bent flat material with a constant layer thickness or a material with a varying layer thickness, in particular a bent material with a varying layer thickness.

With the objects of the invention in view, there is concomitantly provided an energy storage device, in particular an energy storage device for a vehicle, comprising a plurality of energy storage cells disposed in a row, and a cell connector according to at least one of the embodiments of the invention.

Other features which are considered as characteristic for the invention are set forth in the appended claims.

Although the invention is illustrated and described herein as embodied in a cell connector for an energy storage device, and an energy storage device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1a is a diagrammatic, a top-plan view of an energy storage device with cell connectors, leaving out a temperature control structure;

FIG. 1b is a perspective illustration of an energy storage device with cell connectors, leaving out a temperature control structure from FIG. 1;

FIG. 2a is a perspective illustration of a cell connector from FIG. 1 with a temperature control structure;

FIG. 2b is a perspective illustration of a cell connector on the connection side from FIG. 1 with a temperature control structure;

FIG. 3a is a perspective illustration of a further embodiment of a temperature control structure of a cell connector;

FIG. 3b is a perspective illustration of a further embodiment of a temperature control structure of a cell connector;

FIG. 3c is a perspective illustration of a further embodiment of a temperature control structure of a cell connector;

FIG. 3d is a perspective illustration of a further embodiment of a temperature control structure of a cell connector;

FIG. 4a is a perspective illustration of a further embodiment of a cell connector;

FIG. 4b is a side view of the cell connector according to FIG. 4a;

FIG. 5a is a perspective illustration of a further embodiment of a cell connector;

FIG. 5b is a side view of the cell connector according to FIG. 5a;

FIG. 6a is a perspective illustration of a further embodiment of a cell connector; and

FIG. 6b is a perspective illustration of a cell connector according to FIG. 6a without a temperature control structure.

### DETAILED DESCRIPTION OF THE INVENTION

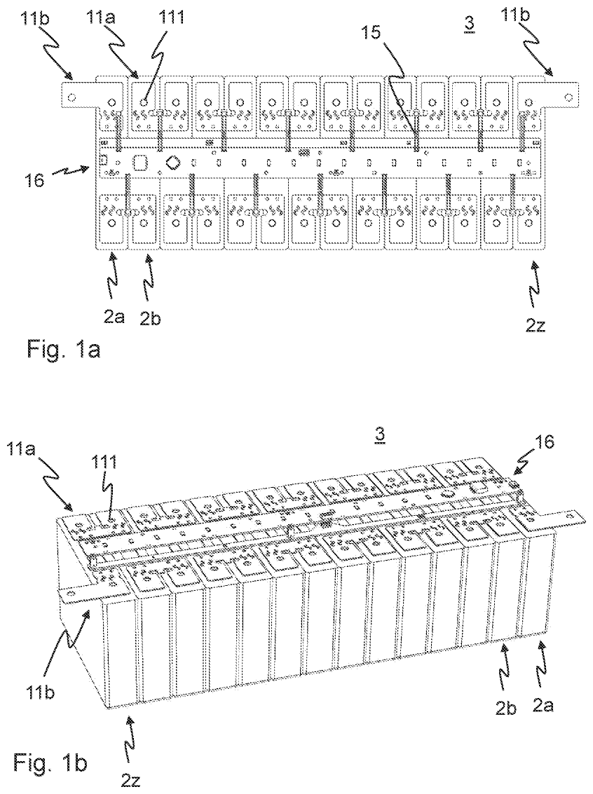

Referring now to the figures of the drawings in detail and first, particularly, to FIG. 1 thereof, there is seen an energy storage device 3 in its entirety. The energy storage device 3 is in particular a battery, for example for an electric vehicle with an electric drive. The energy storage device has a plurality of energy storage cells 2a, 2b, 2z disposed in a row.

The energy storage cells 2a, 2b, 2z each have two pole contacts 22a, 22b hidden by cell connectors 11a, 11b in FIG. 1, specifically one pole contact 22a for an anode and one pole contact 22b for a cathode. The pole contacts 22a, 22b can have a substantially flat surface or can be formed as small plates.

FIG. 1 also shows open loop and/or closed loop control electronics 16 which are electrically connected to the cell connectors 11a, 11b by connection elements 15.

The cell connectors 11a, 11b can be welded to the pole contacts 22a, 22b, for example. Furthermore, the cell connectors 11a, 11b can have through openings 111. These through openings 111 can serve for positioning when fastening the cell connectors 11a, 11b to the pole contacts 22a, 22b. In addition, the through openings 111 can serve as inspection openings. If required, for example measuring lines can be attached, through the through openings 111, to threaded holes located beneath the through openings on the pole contacts 22a, 22b. In this way, for example, the contacting of the cell connectors 11a, 11b to the pole contacts 22a, 22b can be checked.

In the exemplary embodiment, fourteen energy storage cells 2a, 2b, 2z are shown by way of example, which are electrically connected to each other in a series circuit by the cell connectors 11a, 11b. For this purpose, the energy storage cells 2a, 2b, 2z are each rotated relative to one another, so that the pole contact 22a of the anode of the energy storage cell 2a is opposite the pole contact 22b of the cathode of the adjacent energy storage cell 2b, or the pole contact 22b of the cathode of the energy storage cell 2b is opposite the pole contact 22a of the anode of the adjacent energy storage cell 2a. The pole contact 22b of the cathode of the first energy storage cell 2a is connected to the terminal cell connector 11b. The pole contact 22a of the anode of the first energy storage cell 2a is connected by the cell connector 11a to the pole contact 22b of the cathode of the adjacent, second energy storage cell 2b. The pole contact 22a of the anode of the second energy storage cell 2b is in turn connected to the pole contact 22b of the cathode of the third energy storage cell by a cell connector 11a, and so on. The pole contact 22a of the anode of the last energy storage cell 2z is connected to the cell connector 11b. The cell connectors 11b are intended to electrically connect the energy storage device 3 to an electrical consumer, not shown, for example the electric motor of an electric vehicle. The two cell connectors 11b thus form the energy storage device connections, i.e. the cathode and anode of the entire energy storage device 3.

In alternative embodiments of an energy storage device 3, a different number of energy storage cells can also be provided and/or the energy storage cells can be connected in parallel. For this purpose, the cell connectors 11a, 11b can, for example, connect the electrical connections 22a of the anodes of two or more energy storage cells or the electrical connections 22b of the cathodes of two or more energy storage cells. The energy storage cells can also be disposed in a row in the same orientation, i.e. not rotated, so that the electrical connections of the cathodes of the energy storage cells of the energy storage device 3 are disposed along a first line and the electrical connections of the anodes of the energy storage cells are disposed along a second line running parallel to the first line.

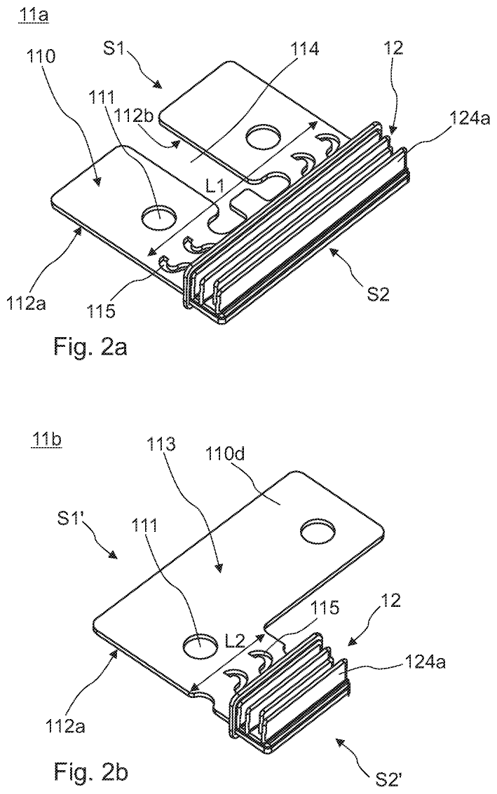

FIGS. 2a and 2b show cell connectors 11a, 11b for electrically contacting the pole contacts 22a, 22b of the energy storage cells 2a, 2a, 2z with a temperature control structure 12. In the exemplary embodiment according to FIGS. 1a and 1b, two terminal cell connectors 11b and thirteen cell connectors 11a are shown.

The cell connectors 11a are intended to electrically connect a pole contact 22a of one energy storage cell, for example 2a, to a pole contact 22b of an adjacent energy storage cell, for example 2b. For this purpose, the cell connectors 11a have a main body 110 with a first contact face 112a and a second contact face 112b, which are each connected, for example welded, to a pole contact 22a, 22b.

The two cell connectors 11b are intended to provide, at the first energy storage cell 2a and the last energy storage cell 2z, a contacting device to an electrical consumer, not shown, for example an electric motor of an electric vehicle, or to an adjacent energy storage device. The cell connectors 11b have a main body 113 with a contact face 112a which is connected, for example welded, to the pole contact 22b of the cathode of the first energy storage cell 2a or the pole contact 22a of the anode of the last energy storage cell 2z. Furthermore, the main body 113 has a current tap 110d. The current taps 110d of the two cell connectors 11b thus form the connections of the anode and cathode of the energy storage device 3.

The main bodies 110, 113 of the cell connectors 11a, 11b are formed of an electrically conductive flat material with preferably a constant layer thickness, for example a sheet metal. The respective main body 110, 113 has a first side S1, S1′ and a second side S2, S2′ and is overmolded in each case in the region of the second side S2, S2′ in a partial region 110a hidden in FIGS. 2a and 2b with a temperature control structure 12 which increases the surface area of the cell connector 11a, 11b. The temperature control structure 12 has, for example, a plurality of temperature control ribs 124a running parallel to one another.

In an alternative embodiment, not shown, the main body 110, 113 can be formed of a bent flat material with a constant layer thickness or a material with a varying layer thickness, for example a bent material with a varying layer thickness.

The temperature control structure 12 is preferably a thermally conductive, electrically insulating material, in particular plastic.

In the cell connector 11a, the temperature control structure 12 extends along the entire length L1 of the first side S1. In the cell connector 11b, the temperature control structure 12 extends only along the length L2 of the first side S1′ in the region of the contact face 112a.

A recess 114 may be provided between the contact faces 112a, 112b of the cell connector 11a. On one hand, this recess shifts the flow of current and the resultant heat into the partial region 110a overmolded by the temperature control structure 12. On the other hand, the main body 110 thus has a higher elasticity. It is thus possible to better compensate for thermal expansions or movements of the adjacent energy storage cells 2a, 2b, 2z relative to each other.

Furthermore, the main bodies 110, 113 of the cell connectors 11a, 11b can have recesses 115, for example in the form of crescent shaped through openings. These also increase the elasticity of the main bodies 110, 113.

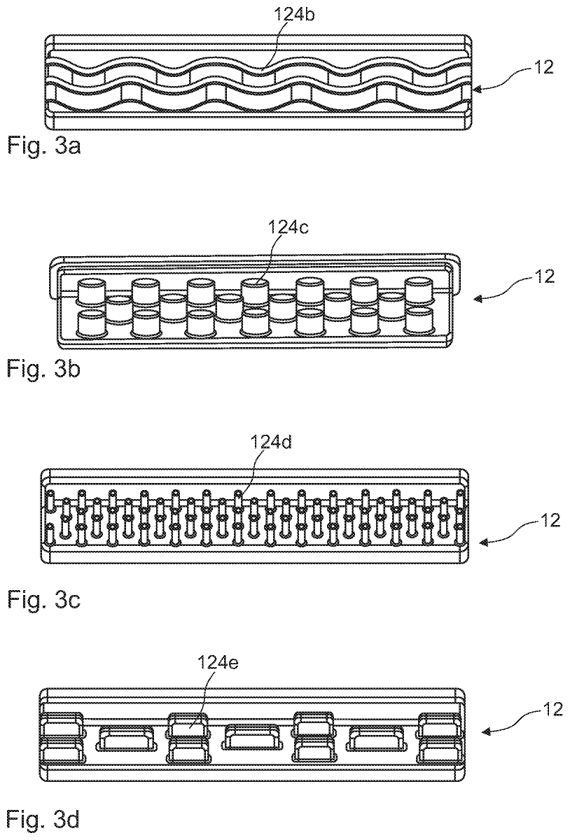

FIGS. 3a to 3d show various embodiments of the temperature control structure 12. Temperature control wave structures 124b, temperature control nubs 124c, temperature control pins 124d, or temperature control bars 124e may be provided as the temperature control structure.

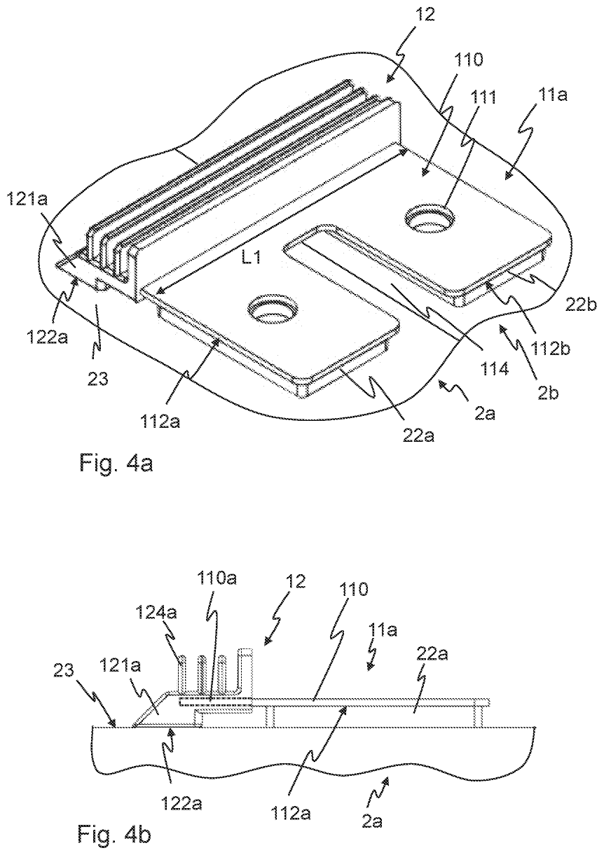

FIGS. 4a, 4b, 5a, 5b, 6a and 6b show alternative embodiments of cell connectors 11a, in which an additional contact element 121a, 121b, 121c is provided which is in direct contact with the upper side 23 of the energy storage cell by a contact face 122a, 122b, 122c. This allows for temperature control of the energy storage cells 2a, 2b, 2z.

The contact element 121a of the temperature control structure 12 from FIGS. 4a and 4b is injection molded in this case around the end region of the main body 110 in such a way that its contact face 122a rests on the surface of the energy storage cell or bridges the height of the pole contact 22a, cf. FIG. 4b.

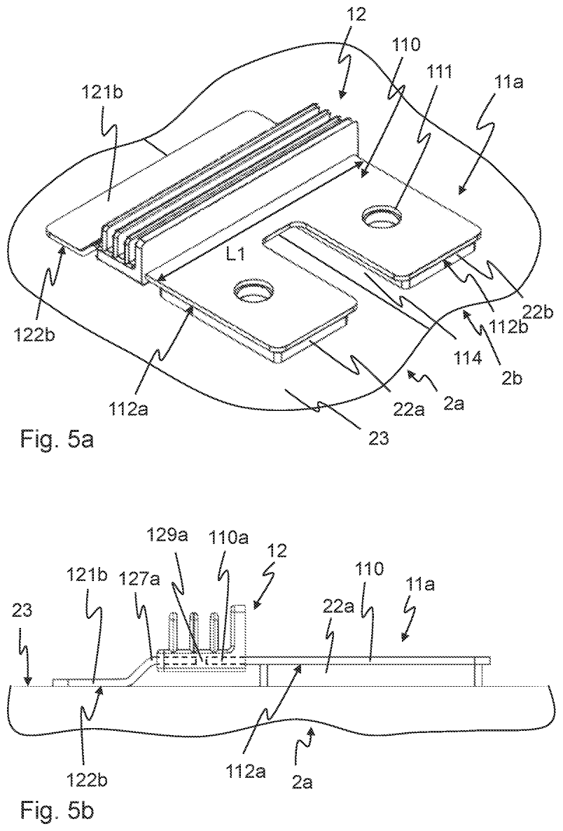

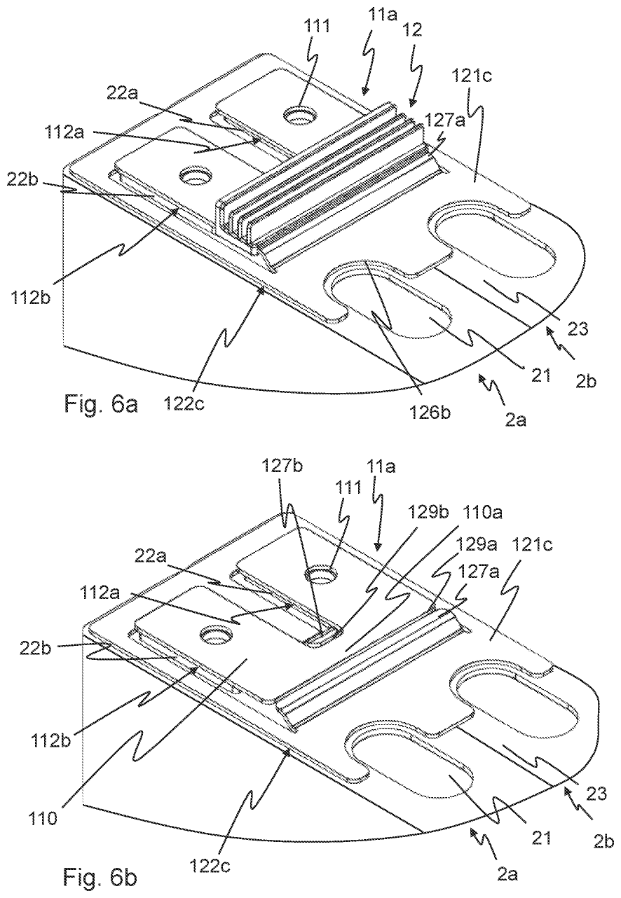

FIGS. 5a and 5b and FIGS. 6a and 6b show two further alternative embodiments of cell connectors 11a with a contact element 121b, 121c, for example a contact plate.

According to FIGS. 5a and 5b, the contact element 121b is overmolded by the temperature control structure 12 and has an offset 127a. The offset 127a may have substantially the same height as the pole contacts 22a, 22b with respect to the upper side 23. This allows the main body 110 and the contact element 121b to be connected to each other, for example, in one plane, with the result that the contact element 121b rests directly on the upper side of the energy storage cells. A gap 129a is provided between the main body 110 and the contact element 121b so that the main body 110 and the contact element 121b are not in direct contact with each other. The main body 110 and the contact element 121b are connected to each other by the temperature control structure 12. The main body 110 and the contact element 121b, 121c can thus be electrically insulated from each other by an electrically non conductive temperature control structure 12. The contact element 121b can be made of the same material as the main body 110.

The variant of FIGS. 6a and 6b has an additional offset 127b between the two contact faces 112a, 112b. The contact element 121c extends as far as the degassing openings 21 and surrounds the pole contacts 22a, 22b of the energy storage cells 2a, 2b. The additional offset 127b can additionally increase the heat conduction between the contact element 121c and the temperature control structure 12 as well as the mechanical stability of the cell connector 11a.

The offset 127a, 127b can be created, for example, by two folds of a plate shaped raw material, for example a metal sheet, as can be seen in FIG. 6b, in which the temperature control structure has been omitted for illustrative purposes.

The main body 110 and the contact element 121b, 121c can advantageously be made, for example cut or punched, from a common plate shaped blank.

Corresponding contact elements can also be provided for the end-side cell connectors 11b. The geometry of the contact element for a cell connector 11b can be easily adapted to the geometry of the cell connector 11b.

The cell connectors 11a, 11b or the temperature control structures 12 can further have an interface to a thermal conditioning system, for example a temperature control channel (not illustrated), and can be connected to the latter, for example welded or adhesively bonded, preferably in the region of the temperature control structure 12. For the connection to a cell connector 11a, 11b, the temperature control channel can for example have through openings into which the cell connectors 11a, 11b and/or the temperature control structure 12 can be introduced. The interface to the thermal conditioning system can be provided for example on the temperature control structure 12. The interface can for example be configured in such a way that the interface can close the through openings of a temperature control channel. The temperature control channel can for example be provided for the purpose of receiving and/or conducting a temperature control fluid, for example a temperature control liquid.

Alternatively, the cell connectors 11a, 11b can also be used without a temperature control channel. In this case, the ambient air can be used for temperature control, for example.

The following is a summary list of reference numerals and the corresponding structure used in the above description of the invention:

### LIST OF REFERENCE SIGNS

2a first energy storage cell
2b second energy storage cell
2z last energy storage cell
3 energy storage device
11a cell connector
11b cell connector
111 through opening
110 main body
113 main body
110a partial region
110d current tap
112a contact face
112b contact face
12 temperature control structure
121a contact element
121b contact element
121c contact element
122a contact face
122b contact face
122c contact face
124a temperature control ribs
124b temperature control wave structure
124c temperature control nubs
124d temperature control pins
124e temperature control bars
127a offset
127b offset
129a gap
129b gap
15 connection elements
16 open-loop and/or closed-loop control electronics
21 degassing opening
22a pole contact
22b pole contact
23 upper side

1. A cell connector for an energy storage device for electrically contacting a first pole contact of a first energy storage cell and a second pole contact of a second energy storage cell of the energy storage device or of an energy storage device for a vehicle, the cell connector comprising:
an electrically conductive main body having a partial region, having a first contact face configured to electrically contact the first pole contact, and having a second contact face configured to electrically contact the second pole contact; and
a temperature control structure;
said partial region of said main body being provided or overmolded with said temperature control structure for increasing a surface area of the cell connector.

2. A cell connector for an energy storage device for electrically contacting a pole contact of an energy storage cell of the energy storage device or of an energy storage device for a vehicle, cell connector comprising:
an electrically conductive main body having a partial region and having a contact face configured to electrically contact the pole contact;
a current tap; and
a temperature control structure;
said partial region of said main body being provided or overmolded with said temperature control structure for increasing a surface area of the cell connector.

3. The cell connector according to claim 1, wherein said main body has a first side and a second side, and said temperature control structure extends along the entire length of said first side.

4. The cell connector according to claim 2, wherein said main body has a first side and a second side, and said temperature control structure extends only along a length of said first side in a region of said first contact face.

5. The cell connector according to claim 3, wherein the first side of said main body extends in a contacting direction of the energy storage cells.

6. The cell connector according to claim 4, wherein the first side of said main body extends in a contacting direction of the energy storage cells.

7. The cell connector according to claim 1, wherein said first and second contact faces are separated from one another by at least one recess.

8. The cell connector according to claim 1, wherein said temperature control structure includes a plurality of at least one of temperature control ribs or corrugated temperature control ribs or temperature control nubs or temperature control pins or temperature control bars.

9. The cell connector according to claim 2, wherein said temperature control structure includes a plurality of at least one of temperature control ribs or corrugated temperature control ribs or temperature control nubs or temperature control pins or temperature control bars.

10. The cell connector according to claim 8, wherein said at least one of temperature control ribs, temperature control nubs, temperature control pins or temperature control bars are disposed at least one of in series with one another, in parallel with one another or at equal distances from one another.

11. The cell connector according to claim 9, wherein said at least one of temperature control ribs, temperature control nubs, temperature control pins or temperature control bars are disposed at least one of in series with one another, in parallel with one another or at equal distances from one another.

12. The cell connector according to claim 1, wherein said temperature control structure is formed of a thermally conductive, electrically insulating material or a thermally conductive, electrically insulating plastic.

13. The cell connector according to claim 2, wherein said temperature control structure is formed of a thermally conductive, electrically insulating material or a thermally conductive, electrically insulating plastic.

14. The cell connector according to claim 1, which further comprises a contact element having a contact face for contacting a surface of an energy storage cell, said contact element being connected to said temperature control structure.

15. The cell connector according to claim 2, which further comprises a contact element having a contact face for contacting a surface of an energy storage cell, said contact element being connected to said temperature control structure.

16. The cell connector according to claim 14, wherein the contact element is part of said temperature control structure.

17. The cell connector according to claim 15, wherein the contact element is part of said temperature control structure.

18. The cell connector according to claim 14, wherein the contact element is a contact plate or a sheet metal contact plate.

19. The cell connector according to claim 15, wherein the contact element is a contact plate or a sheet metal contact plate.

20. The cell connector according to claim 14, wherein:
said contact element and said main body define a gap therebetween; and
said temperature control structure joins said main body and said contact element to one another in a region of said gap.

21. The cell connector according to claim 15, wherein:
said contact element and said main body define a gap therebetween; and
said temperature control structure joins said main body and said contact element to one another in a region of said gap.

22. The cell connector according to claim 14, wherein at least one of said first or second contact faces and said contact face of said contact element are positioned with a vertical offset relative to one another.

23. The cell connector according to claim 22, wherein said vertical offset is formed by at least one bent portion of said contact element.

24. The cell connector according to claim 23, wherein said at least one bent portion is provided on both sides of said temperature control structure.

25. The cell connector according to claim 14, wherein said main body and said contact element are punched parts or cut parts or laser cut parts, from a common plate-shaped blank.

26. The cell connector according to claim 15, wherein said main body and said contact element are punched parts or cut parts or laser cut parts, from a common plate-shaped blank.

27. The cell connector according to claim 14, wherein said contact element (122a, 122b, 122c) extends as far as at least one degassing opening formed in at least one of the first or second or a last energy storage cell or as far as degassing openings of the first and second energy storage cells or at least partially encloses said degassing openings.

28. The cell connector according to claim 15, wherein said contact element (122a, 122b, 122c) extends as far as at least one degassing opening formed in at least one of the first or second or a last energy storage cell or as far as degassing openings of the first and second energy storage cells or at least partially encloses said degassing openings.

29. The cell connector according to claim 1, wherein said temperature control structure forms an interface to a thermal conditioning system.

30. The cell connector according to claim 2, wherein said temperature control structure forms an interface to a thermal conditioning system.

31. The cell connector according to claim 29, wherein the thermal conditioning system has at least one temperature control channel in which said temperature control structure of the cell connector is positioned.

32. The cell connector according to claim 30, wherein the thermal conditioning system has at least one temperature control channel in which said temperature control structure of the cell connector is positioned.

33. The cell connector according to claim 1, wherein said electrically conductive main body is formed of a flat material or a plate-shaped flat material with a constant layer thickness or a bent flat material with a constant layer thickness or a material with a varying layer thickness or a bent material with a varying layer thickness.

34. The cell connector according to claim 2, wherein said electrically conductive main body is formed of a flat material or a plate-shaped flat material with a constant layer thickness or a bent flat material with a constant layer thickness or a material with a varying layer thickness or a bent material with a varying layer thickness.

35. An energy storage device or an energy storage device for a vehicle, comprising a plurality of energy storage cells disposed in a row, and a cell connector according to claim 1.

36. An energy storage device or an energy storage device for a vehicle, comprising a plurality of energy storage cells disposed in a row, and a cell connector according to claim 2.
